(19) United States
(12) Patent Application Publication
(10) Pub. No.: US 2011/0289054 A1
(43) Pub. Date: Nov. 24, 2011

(54) Content Management Migration Manager System and Method

(75) Inventor: Rob Keith Johnson, Sharpsburg, GA (US)

(73) Assignee: SOUTHERN COMPANY SERVICES, Atlanta, GA (US)

(21) Appl. No.: 12/771,296

(22) Filed: May 19, 2010

(51) Int. Cl. G06F 17/30

(52) U.S. Cl. 707/626; 707/785; 707/E17.005

(57) ABSTRACT

A content management migration manager method comprises accessing via a web interface executed by a computer an application interface, such as an API, for a first content management system and an application interface (API) for a second content management system. A site associated with the first content management system is thereafter replicated to the second content management system. Each document library folder in the replicated site is duplicated to the second content management system for the replicated site as well as all corresponding users, groups and their associated roles/permissions. Thereafter, one or more folders, users, or permissions existing in the second content management system not also existing in the first content management system may be removed by the content management migration manager.

### TECHNICAL FIELD

The present disclosure generally relates to content management systems, and more particularly, to a system and method for providing migration between different content management systems.

### BACKGROUND

The digital age has provided for more efficient exchanges of information faster than ever before. Instead of creating paper documents that must be mailed or even faxed, more and more people use purely electronic means to communicate and exchange data as part of their work and personal lives. Every day, data is communicated around the world seemingly instantaneously on just about any conceivable type of commercial endeavor by those having common interests and/or commercial associations.

However, these conveniences are not without problems. As an example, consider a situation where a number of a company's employees located at different geographic locations are working together on a specific project or endeavor for their company. While the employees might have historically conducted a large number of face-to-face meetings to share ideas and communicate about their common project, email, video conferences, and other similar digital communication platforms have operated to greatly reduce the need for such gatherings, oftentimes which are overly time consuming and involve great expense and travel.

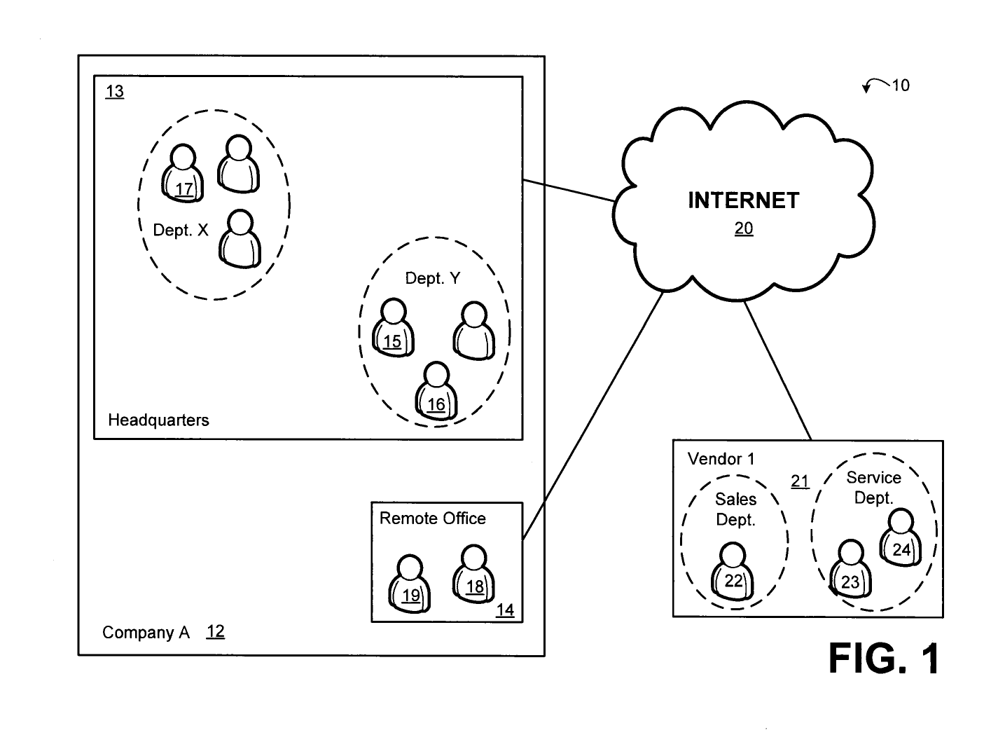

FIG. 1 is a diagram 10 depicting a non-limiting exemplary implementation of a project involving multiple entities, departments, and/or organizations via the Internet (and email). FIG. 1 depicts diagram 10 that comprises Company A (reference numeral 12), which in this non-limiting example includes headquarters 13 and remote office 14. Employees of Company A at remote office 16 may communicate and exchange data with the employees of Company A in Department X (i.e., Marketing) and Department Y (i.e., Engineering) in headquarters 13 via email over the Internet 20.

Further in this non-limiting example, Vendor 1 (reference numeral 21) may be a separate company from Company A located at practically any point in the world and involved in a common project and/or commercial relationship with Company A. However, Vendor 1 may still be able to communicate and exchange project-related documents with the project members of Company A by email over the Internet 20, as one of ordinary skill in the art would know. In this non-limiting example, employee 22 in the Sales Department of Vendor 1 and employees 23 and 23 in the Service Department of Vendor 1 may all participate in a project with Company A and communicate in similar fashion with Company A in regard to the project.

But, even common digital communication platforms, like email, sometimes are not suitable for facilitation of projects, like that described above and depicted in FIG. 1. More specifically, enterprises like Company A might have a large number of ongoing projects at any given time or have a large number of its employees on a given project, such that reliance on email alone for project advancement is not practical.

Thus, in these instances, email and other digital communication platforms may be less than optimal. For example, exchanging project-related documents by email between team members presents substantial versioning problems and confidentiality risks. More specifically, as each project member might receive a latest working copy of a project-related document, a problem can quickly arise in this non-limiting example where multiple project members are revising documents simultaneously, thus creating multiple revised versions moving between project team members such that there is no single current version. As applied to FIG. 1, if Company A employee 17 creates and distributes a project related document to all project members, including employees 15, 16, 18, 19 of Company A and employees 22, 23, and 24 of Vendor 1, the likelihood of multiple revised versions of the document, as created by the recipient project members is substantial, thus resulting in a great likelihood of confusion and delay between project members. Plus, in communicating confidential project-related documents electronically, such as by email over Internet 20, confidentiality risks abound, especially when such sensitive documents are communicated to third parties, like vendors and contractors (such as Vendor 1).

One solution to these problems comprises implementation of content management systems, which may be configured as a collection of procedures used to manage work flow in a collaborative environment. Content management systems, such as Microsoft's SharePoint®, allow for a large number of people, whether inside or outside a company using SharePoint®, to contribute to and share data. These solutions also control access to data based on individual users' roles or permissions, which define what type of information that a user can view and/or edit. Content management solutions, like SharePoint®, can also reduce duplicative input and improve overall communication between project team members.

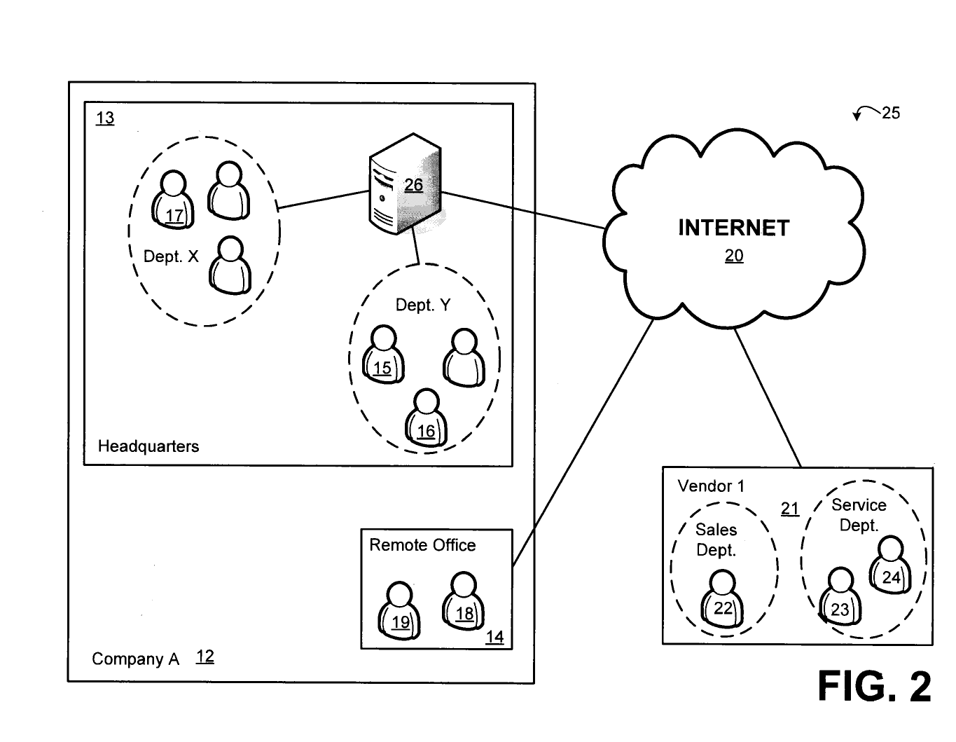

FIG. 2 is a diagram 25 depicting implementation of a content management system on server 26 for the non-limiting exemplary project collaboration shown in FIG. 1 between Company A and Vendor 1. More specifically, server 26 may include a content management system with integrated searching capabilities to allow the various project member users in Company A and Vendor 1, as identified above, to work in a web-based collaboration environment.

This web-based collaboration environment may include the creation of various types of documents and other important information pertinent to the project. In this way, the content management system on server 26 may be used such that any project member users within Company A and Vendor 1 may have access to the contents of the web-based portal such that files may be created and stored locally on server 26 but then accessed by each project member user in accord to the permissions given to that specific user. Plus, the content management system on server 26 may enable project leaders to quickly and easily establish such sites for given projects, thus avoiding the difficulty of attempting to write and establish Internet web sites and ftp sites for project members to access and use.

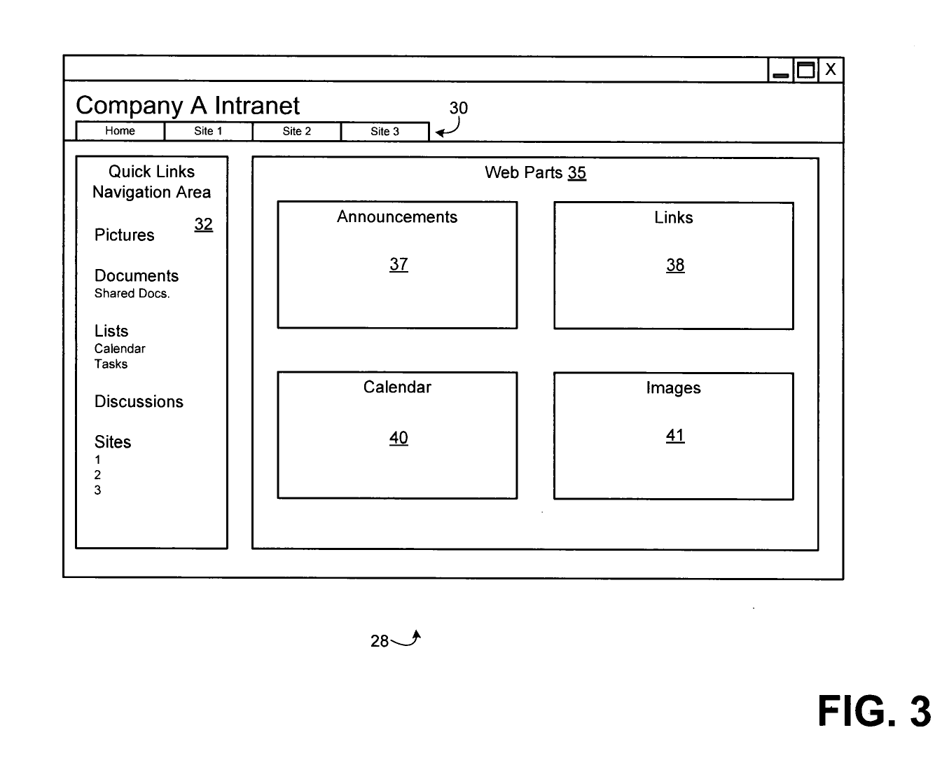

FIG. 3 is a diagram of a non-limiting exemplary user interface 28 associated with the content management system on server 26 in FIG. 2, which may also be recognized as an intranet web portal site. In this non-limiting example, the user interface 28 may include a top link bar 30 with a plurality of tabs associated with various sites. A quick links navigation area 32 may also be included in user interface 28 listing the various types of high-level types of information, such as pictures, shared documents, lists, which may include calendars and tasks, discussions and various sites. User interface 28 may also include a web parts portion 35 that may be configured by employee 15, as shown in the non-limiting example of FIG. 3, to include an announcement section 37, a links section 38, a calendar section 40 and an images section 41. User interface 28 may be configured in accord with content management systems, like Microsoft's SharePoint®, as one of ordinary skill in the art would know.

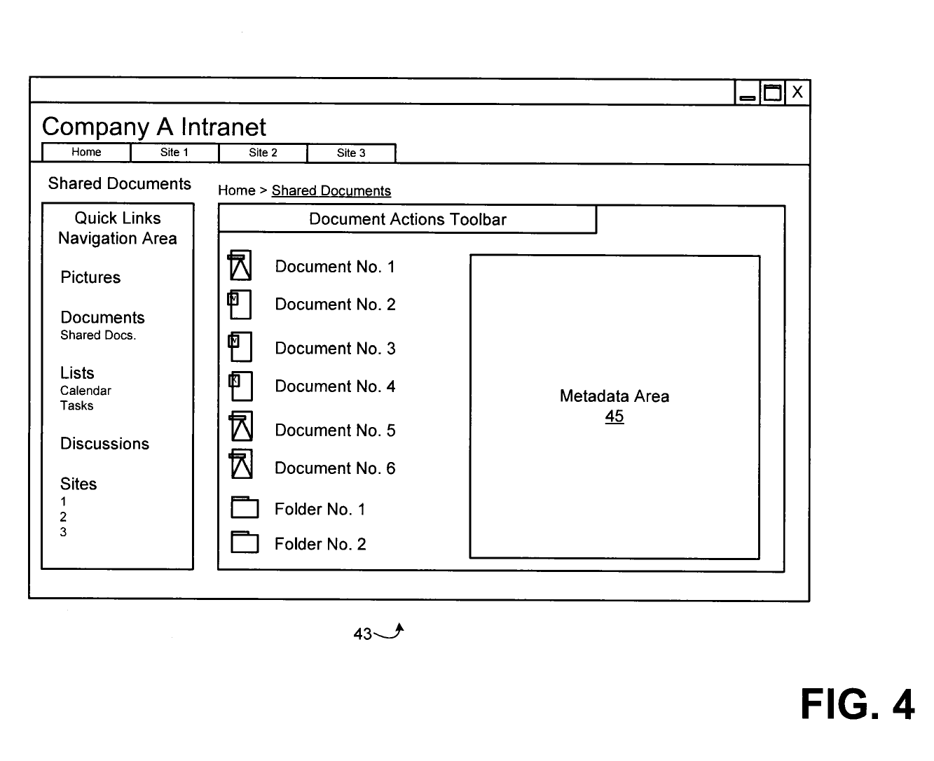

As one of ordinary skill in the art would also know, the shared documents available via the Company A intranet site shown in FIG. 3 may be created and uploaded by the project member users (or those otherwise having access to the Company A intranet site). Thus, FIG. 4 depicts a shared documents interface 43 accessible from the quick links navigation area 32 in FIG. 3. As shown in the non-limiting example of FIG. 4, the shared documents interface 43 contains Document Nos. 1-6, which may be any document type, as one of ordinary skill in the art would know, and Folder Nos. 1 & 2, which themselves may be configured to contain may contain various types of documents. In the non-limiting example of FIG. 4, the meta data area 45 may contain data pertaining to each document and folder type, such as creation date, author, edit date, etc.

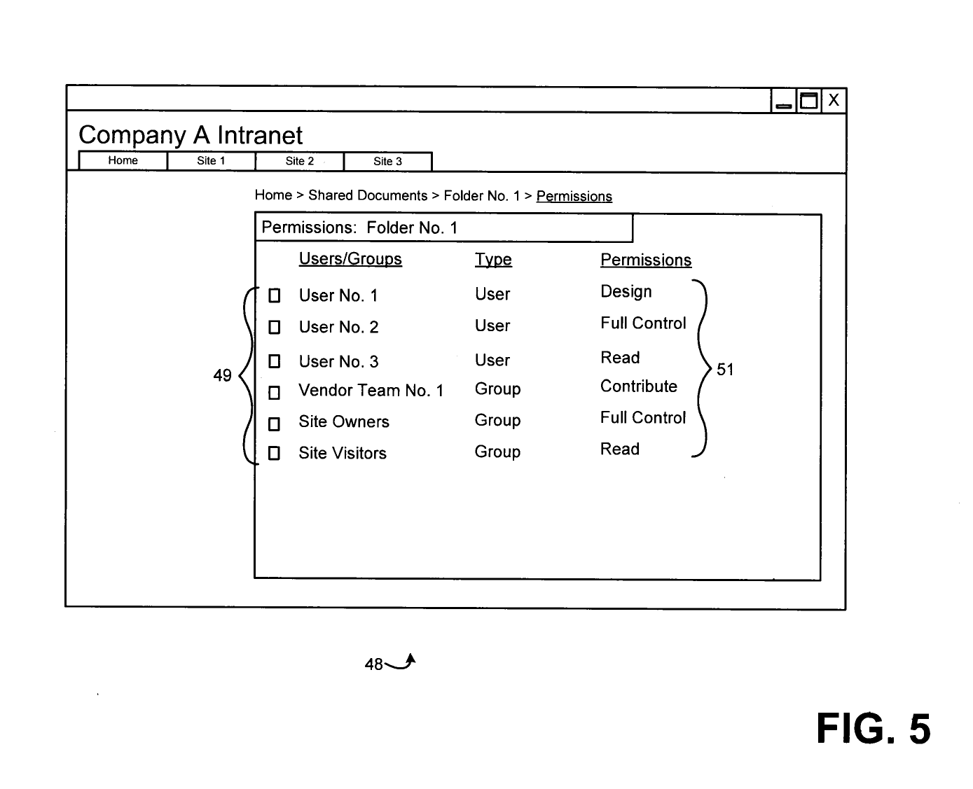

Each project team user identified above and shown in FIG. 1 may access the Company A intranet site stored on server 26 for a given project or other Company A-related endeavor according to their access permission rights. FIG. 5 depicts an exemplary permissions user interface 48 showing various permissions associated with individual project team users and associated groups of users for document Folder No. 1 in FIG. 4. In this non-limiting example, six permissions are displayed on the permissions user interface 48 and may be changed as needed. Specifically, section 49 depicts project team users 1-3, which may, as a non-limiting example, correspond to employee 16 in Department Y, employee 17 in Department X and employee 18 in the remote office 14 of company A, respectively (shown in FIG. 1). Vendor Team No. 1 in this non-limiting example may correspond to all of the employees at Vendor 1 (reference numeral 21) participating in the project with Company A. Likewise, the Site Owner may correspond to employee 15, who may be the project team leader and creator of the Company A intranet site for the given project in this instance. Finally, a Site Visitor group may be established so that anyone having a temporary need to access project related documents can do so, such as employee 19 at remote office 14 for Company A.

Each of these users and groups depicted in FIG. 5 may have similar or different permissions for accessing the content contained in Folder No. 1 (or any other site or library in Company A's intranet site on server 26. In this non-limiting example, User No. 1 (which may be employee 16 of FIG. 1) may have design permission but may not have full control permission like User No. 2 (employee 17). Likewise, User No. 3 (employee 18 at the remote office 14 of company A) may only have read-access to the contents of Folder No. 1 based on the role or level of involvement of employee 18 in the given project.

Further, in its efforts to collaborate on the project with Company A, the group comprising employees 22, 23, and 24 of Vendor 1 may have contribute permission to the contents of Folder No. 1, but may not have full editorial control for files that already exist in Folder No. 1 or that are created by other project team member. The Site Owner, which may be employee 15 and the creator of this intranet web portal site, may have full editorial control over all documents (and permissions of others) as the overall owner of the site.

One of ordinary skill in the art would know that for each site, as shown on top link bar 30 and quick links navigation area 32, which can correspond to a different project or area of Company A, such as accounting, engineering, sales, service, enterprise governance, etc., can have different users and groups with each user and group having a different role (permission level) accordingly. For large enterprises having hundreds of separate sites with potentially hundreds of users for each site and multitudes of document libraries per site, content management systems like the one generically described above, which could include Microsoft's SharePoint®, provide a centralized solution to manage users' roles and contributions to various sites (projects) while likewise avoiding duplicative input amount multiple site users. As a result, communication between site users can be substantially improved by the use of such content management systems.

However, one of the problems that exists in the implementation of such content management systems appears when one content management system on server 26 in FIG. 2 is replaced or upgraded by another more recent version. Moving between versions of even the same branded content management system can present challenges and problems to an enterprise seeking to maintain operation during the upgrade process. If an enterprise, such as Company A, upgrades from one version of its content management system to a more recent version but in the process loses information related to its various sites, which can be a substantial number, including their associated documents libraries, users and/or their respective roles/permissions, the damaging effects to ongoing projects can be devastating.

As a non-limiting example, if Company A implemented Microsoft SharePoint® 2003 as its content management system, upgrading to a more current version, such as SharePoint®2007 or even SharePoint® 2010 would need to import all sites and their respective users, groups and all associated roles for each user and group to be a successful upgrade, as otherwise, projects could be delayed by the inability to access and update project-related information.

Several off-the-shelf solutions exist in the market to aid migration from one content management system, like Microsoft's SharePoint® 2003, to another, such as SharePoint® 2007 or 2010. However, each of these migration aids fail to completely migrate each and every site, user/user ID, and associated role/permission with the granularity needed to insure seamless transition to the more current content management system. For enterprises that implement but a small number of sites in its content management system, migration from one version of a content management system to a more current content management system may not create an onerous task, as a site administrator or another may be able to manually reconfigure all sites, users, and their respective roles/permissions in an acceptable amount of time.

However, for larger enterprises that may contain hundreds of user-created sites within the enterprise each having multiple sites, roles, users and groups, as described above, migration from one version of a content management system to another may take thousands upon thousands of man hours to recreate the data for each site in the new content management system. In this instance, manual reconfiguration of sites, users, groups, and respective roles/permissions is likely impractical, as doing so would likely impact the success of a project or even the business of the enterprise.

Thus, there is a heretofore-unaddressed need to overcome these deficiencies and shortcomings described above.

### DETAILED DESCRIPTION OF DRAWINGS

FIG. 1 is a diagram depicting a non-limiting example of implementation of a project involving multiple entities, departments, and/or organizations via the Internet (and email).

FIG. 2 is a diagram depicting implementation of a content management system on a server for the non-limiting exemplary project collaboration shown in FIG. 1 between Company A and Vendor 1.

FIG. 3 is a diagram of a non-limiting exemplary user interface associated with the content management system on the server in FIG. 2.

FIG. 4 depicts a shared documents interface accessible from the quick links navigation area in FIG. 3.

FIG. 5 depicts an exemplary permissions user interface showing various permissions associated with individual project team users and associated groups of users for document Folder No. 1 in FIG. 4.

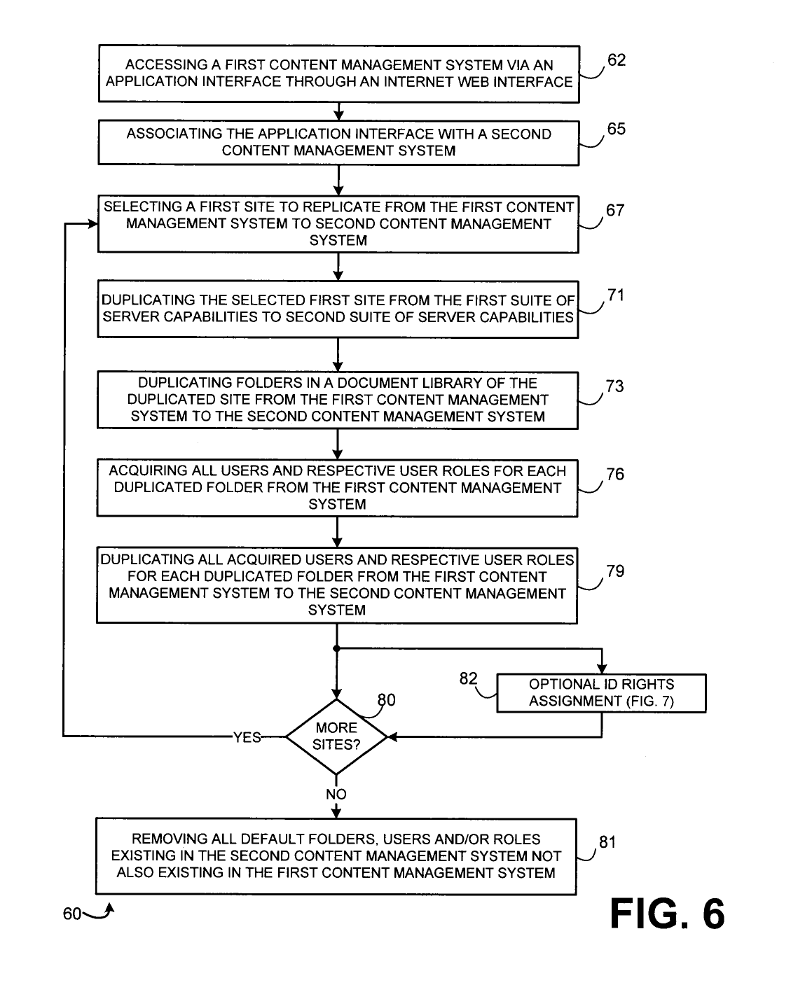

FIG. 6 depicts a flowchart diagram for migrating users, groups, and their respective roles/permissions from one content management system, as depicted in FIGS. 2-5, to another.

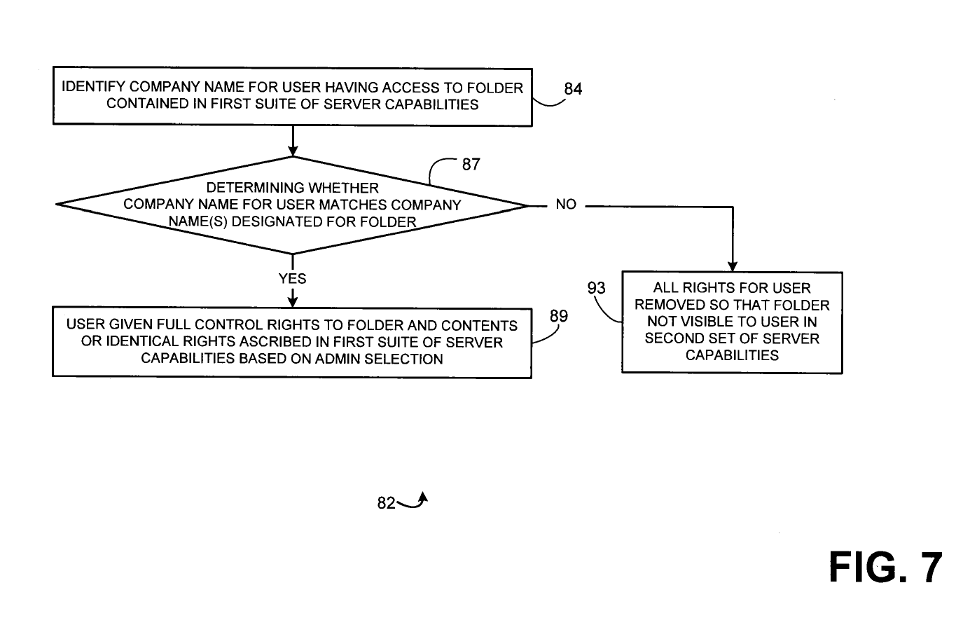

FIG. 7 depicts a sub-process that is a non-limiting example of class reassignment by the migration manager depicted in FIG. 6.

### DETAILED DESCRIPTION

FIG. 6 depicts a flowchart diagram 60 for a migration manager to migrate users, groups, and their respective roles/permissions from one content management system, as depicted in FIGS. 2-5, to another. Diagram 60 involves accessing application program interfaces, or APIs, of the prior version for migrating this data to the new and upgraded version. More specifically, accessing the APIs from both the old and the new version of the content management system, and particularly the dynamic link library files, or DLL files, enable migration of each and every user, group and associated role/permission for each site and its associated folders and document libraries. In this way, the upgraded content management system and quickly and efficiently be configured to include each and every site, folder, library, user, group, and associated role for a seamless transition.

Step 62 in FIG. 6 depicts the accessing of the first content management system, which in this non-limiting example could be an older SharePoint® version, such as SharePoint® 2003, through an internet web interface. In this step 62, the internet web interface accesses the dynamic linking files of the content management system on server 26 to be replaced (i.e., SharePoint® 2003) to access information pertaining to the sites and all associated users, groups, document libraries, and corresponding permissions configured in the content management system. Once accessed, step 65 depicts association with the APIs of the upgraded or current content management system (i.e., SharePoint® 2007 or 2010) intended to replace the prior version, which hereinafter shall be referred to as the second content management system. More specifically, through the Internet web interface, the application interface of the second content management system is acquired in advance of transition of the sites and all corresponding users, groups, libraries, and roles can be transferred over from the first content management system.

Thereafter, in step 67, a first site in the first content management system (i.e., SharePoint® 2003) is selected for replication to the second content management system. Upon selecting the first site to be replicated in step 67, step 71 directs the duplication of the first site in from the first content management system to the second content management system (i.e., SharePoint® 2007 or 2010). Once this first site is replicated, step 73 directs the duplication of the folders that may be found in the document library for the replicated site in the first content management system to a corresponding document library in the second content management system for the replicated site. Thus, as a non-limiting example, Folder Nos. 1 and 2 depicted in shared documents interface 43 of FIG. 4 would be duplicated from the first content management system (i.e., SharePoint® 2003) into the second (upgraded) content management system (i.e., SharePoint® 2007 or 2010).

Upon duplication of folders, step 76 would follow, which directs the acquisition of all users, groups, and their respective user roles/permission for each folder duplicated from the first content management system to the second. The DLL files of the first content management system, as accessed by the Internet web interface in step 62, would provide this information in step 76. More specifically and as a non-limiting example, as shown in the permissions interface 48 of FIG. 5, each permission for each user and group would be acquired by step 76 for a particular folder being duplicated from the first content management system to the second content management system.

Thereafter, in step 79, the acquired users and their respective roles/permissions are duplicated to the second content management system for the replicated folder in which they were acquired from or associated with in the first content management system. Thus, for a given replicated site, each folder, document therein, and all users, groups, and respective roles/permissions are migrated by the migration manager system and method from the first content management system to the second (and updated) content management system such that when Company A crosses over to utilizing the second content management system the transition is seamless to users, since they each have the same access levels as with the first content management system.

The preceding steps 67, 71 73, 76 and 79 may be repeated for each site in the first content management system until all sites in the first content management system are duplicated to the second content management system. The migration manager can, as a non-limiting example, implement a routine in step 80 that makes the decision of whether additional sites for duplication exist in the first content management system such that the process reverts to step 67 if the result is affirmative.

Once all sites to be duplicated have been duplicated to the second content management site, step 81 depicts the removal of any and all default folders, users, and or roles in the second content management system not also existing in the first content management system. In this step 81, the migration manager may look to determine, identify and remove any default users' roles and folders in the second content management system that are not also found in the first content management system (the previous version already operating on server 26) since those default roles, users and folders will not likely be needed but may merely be defaults defined by the manufacturer of the second content management system. Since the migration manager did not find corresponding items in the first content management system, step 81 may be a type of housekeeping operation to remove any default folders that could create errors, problems or confusion among users of the second content management system.

As an alternative embodiment, step 79 of flowchart 60 in FIG. 6 may be followed by additional steps to recalibrate user roles in accordance with a predetermined class variable. As a non-limiting example, Company A may have instances where one or more individuals or entities outside of Company A are allowed to externally access sites on its content management system. In this non-limiting example, multiple vendors may have participation roles on a given project such that they have varied levels of permission to select sites of Company A's intranet provided by its content management system. In an effort to insure confidentiality or to prevent unintentional access of confidential document and/or items, the migration manager may be configured to evaluate a user's class and assign that user's role in the second content management system accordingly.

FIG. 7 depicts sub-process 82, which is a non-limiting example of class reassignment by the migration manager depicted in FIG. 6. More specifically, sub-process 82 may be implemented as a step positioned after step 79 in FIG. 6 and prior to decision step 81 in FIG. 6, as shown in FIG. 6. In FIG. 7, step 84 depicts the identification of the company name for a user having access to a folder contained in the first content management system. If Vendor 1 and its employees 23 and 24 are involved in a project with Company A such that they have permission to access a site on Company A's intranet provided by the first content management system, sub-process 82 can be implemented to ensure that the employees 23 and 24 are not unintentionally given access to folders for projects for which they are not associated with and have no reason to gain access to for security purposes. One of ordinary skill in the art would know that a user's company association is but one variable for this class evaluation sub-process that could be chosen, as other variables could also be selected for role reassignment as well.

Nevertheless, step 84 includes the identification of the company name for which a comparison will be made in step 87 discussed below. Step 87 depicts the decision step of determining whether or not a company name associated with an individual user matches the company name designated for the folder being duplicated from the first content management system to the second content management system. Thus, in this non-limiting example, for a folder for which Vendor 1 is associated with the project for the folder being duplicated, the company name associated for the employee 23 of Vendor 1 would be recognized as a correct or an appropriate company name having access and permission for the folder for Vendor 1. Likewise, steps 84 and 87 can also be configured to accept the company name of users of Company A, as those users would also likely need access to the duplicated folders in the second content management system for their own company.

Thus, when the company name of a user is deemed to match either Company A or Vendor 1 (in this non-limiting example), step 89 follows and ascribes to such a user full control rights to the folder by the migration manager or some other predetermined access level. If the result of decision step 87 is a non-match, then all rights for that user can be removed such that the folder is not even visible to the user upon accessing the Company A's intranet provided by the second content management system. In this way, sub-process 82 can be utilized to reset permission levels for certain project types and/or to insure confidentialities across company lines and/or between third parties.

As discussed above, the migration manager's process of accessing the dynamic link library files of both the first and second content management systems and then replicating each site and underlying folder, user, group and associated role/permission, provides a quick and seamless transition from a first content management system to a second content management system on server 26. This migration manager described above migrates information at a substantially deeper level and manner than may be provided in other commercially available solutions, thereby saving an administrator, site owner, or another substantial man hours from having to manually replicate in the second content management system each user, group, and role as contained in the first content management system.

One of ordinary skill would know that the migration manager described herein may be embodied in software or code executed by general purpose hardware. As an alternative, the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts described herein depict the functionality and operation the migration manager system and method. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 503 in a computer system or other system. The machine code may be converted from the source code, etc. If embodied in hardware, each block may represent a circuit or a number of interconnected circuits to implement the specified logical function(s).

Although the flowcharts described herein show a specific order of execution, it is understood that the order of execution may differ from that which is depicted. Also, two or more blocks shown in succession may be executed concurrently or with partial concurrence. Further, in some embodiments, one or more of the blocks may also be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments and non-limiting examples are merely possible examples of implementations, merely set forth for a clear understanding of the principles disclosed herein. Many variations and modifications may be made to the above-described embodiment(s) and non-limiting examples without departing substantially from the spirit and principles disclosed herein. All such modifications and variations are intended to be included herein within the scope of this disclosure and protected by the following claims.

Therefore, the following is claimed:

1. A content management migration manager method, comprising the steps of:
accessing an interface for a first content management system implemented by a processor and an interface for a second content management system interface implemented by a processor;
replicating a site associated with the first content management system to the second content management system;
duplicating a folder in a library associated with the replicated site to the second content management system;
duplicating one or more users and roles for each respective one or more users for each folder duplicated from the first content management system to the second content management system; and
removing one or more folders, users, or permissions existing in the second content management system not also existing in the first content management system.

2. The method of claim 1, further comprising the step of:
duplicating a user group and permissions for each user associated with the user group for a duplicated folder from the first content management system to the second content management system.

3. The method of claim 1, further comprising the step of:
comparing a field attribute for a folder existing the first content management system to a corresponding field attribute for a user to determine if the folder field attribute matches the user field attribute.

4. The method of claim 1, further comprising the step of:
setting permissions for the user to a first predetermined level if the folder field attributed matches the user field attribute.

5. The method of claim 4, wherein the first predetermined level is full access.

6. The method of claim 1, further comprising the step of:
setting permissions for the user to a second predetermined level if the folder field attributed does not match the user field attribute.

7. The method of claim 6, wherein the second predetermined level is a restricted access level.

8. The method of claim 1, where in the second content management system is a more recent version of the first content management system.

9. A non-transitory computer-readable medium embodying a program executable on a computing device, the program comprising:
code that accesses an interface for a first content management system and an interface for a second content management system interface;
code that replicates a site associated with the first content management system to the second content management system;
code that duplicates a folder in a library associated with the replicated site to the second content management system;
code that duplicates each user identity and respective permissions for each user identity associated with the duplicated folder from the first content management system to the second content management system; and
code that removes all folders and user identities found in the second in the second content management system not also found in the first content management system.

10. The program of claim 9, further comprising:
code that duplicates a user group and respective permission for each user associated with the user group associated with the duplicated folder from the first content management system to the second content management system.

11. The program of claim 9, further comprising:
code that compares a field attribute for a folder existing in the first content management system to a corresponding field attribute for a selected user to determine if the folder field attribute matches the user field attribute.

12. The program of claim 11, further comprising:
code that sets permissions for the selected user to a first predetermined level if the folder field attributed matches the user field attribute.

13. The program of claim 12, wherein the first predetermined level is full access.

14. The program of claim 11, further comprising:
code that sets permissions for the selected user to a first predetermined level if the folder field attributed does not match the user field attribute.

15. The program of claim 14, wherein the second predetermined level is a restricted access level.

16. The program of claim 9, where in the second content management system is a more recent version of the first content management system.

17. A system, comprising:
at least one computing device;
an interface accessible to the computing device and communicably coupled with a first content management system interface and a second content management system interface;
a replication application accessible by the computing device that replicates a predetermined site from the first content management system to the second content management system, and for the predetermined replicated site, duplicates each folder contained in a document library for the site from the first content management system to the second content management system, including each user and group having access to one or more filed contained in the duplicated folder and all associated roles for each user and group; and
a clean-up application accessible by the computing device that removes folders, user identities, groups, and associated roles found in the second in the second content management system not also found in the first content management system.
